(19) United States
(12) Patent Application Publication
(10) Pub. No.: US 2026/0170519 A1
(43) Pub. Date: Jun. 18, 2026

(54) INFORMATION PROCESSING SYSTEM, INFORMATION PROCESSING METHOD, AND PROGRAM

(71) Applicant: NTT DATA JAPAN CORPORATION, Tokyo (JP)

(72) Inventors: Shinsaku MINAMIDA, Tokyo (JP); Yuichiro NAKAMURA, Tokyo (JP)

(73) Assignee: NTT DATA JAPAN CORPORATION, Tokyo (JP)

(21) Appl. No.: 19/125,939

(22) PCT Filed: Oct. 30, 2023
(86) PCT No.: PCT/JP2023/039095

§ 371 Date: Apr. 30, 2025

(30) Foreign Application Priority Data
Nov. 1, 2022 (JP) 2022-175602

(51) Int. Cl. G06Q 30/0202; G06Q 30/02; G06Q 30/0204; G06Q 40/06

(52) U.S. Cl. CPC G06Q 30/0202; G06Q 30/02; G06Q 30/0204; G06Q 40/06

(57) ABSTRACT

An information processing system includes a company database configured to store sales amounts and greenhouse gas emission amounts of companies, an acquisition unit configured to acquire transaction amounts between a reporting company and trading partner companies, and an emission amount calculation unit configured to calculate allocated emission amounts of the trading partner companies allocated to the reporting company using the sales amounts and greenhouse gas emission amounts of the trading partner companies stored in the company database and the transaction amounts acquired by the acquisition unit.

### TECHNICAL FIELD

The present invention relates to an information processing system, an information processing method, and a program.

Priority is claimed on Japanese Patent Application No. 2022-175602, filed Nov. 1, 2022, the content of which is incorporated herein by reference.

### BACKGROUND ART

As decarbonization is becoming a growing social demand, various infrastructures are being developed to accompany it, and companies are actively making their own Greenhouse Gas (hereinafter, referred to as “GHG”) emission amounts visible and improving management efficiency based on that data (for example, Patent Document 1).

### CITATION LIST

### Patent Document

Patent Document 1: Japanese Patent No. 7084584

### SUMMARY OF INVENTION

### Technical Problem

As a GHG emission amount that a company is required to visualize, it is required to calculate greenhouse gases emitted at every stage of business activities, for example, raw material procurement, manufacturing, logistics, sales, disposal, and the like, which are GHG emission amounts by other companies (trading partner companies) that are related to its business activities.

For example, there is a system in which a company calculates a ratio of its own activity volume (physical volume or monetary data) to an activity volume of other companies related to a corresponding activity, and calculates an emission amount for each category by multiplying the calculated ratio by the GHG emission amounts of the other companies and emission coefficients (also called emission basic units) published by various organizations.

However, to calculate the GHG emission amount, it is necessary to organize trading partners, and the like, and make inquiries to them to calculate the emission amount for each trading partner company, which requires a lot of effort and time.

The present invention has been made to solve the problems described above, and its objective is to provide an information processing system, an information processing method, and a program that can easily calculate the GHG emission amount.

### Solution to Problem

To solve the problems described above, an information processing system according to one aspect of the present invention includes a company database configured to store sales amounts and greenhouse gas emission amounts of companies, an acquisition unit configured to acquire transaction amounts between a reporting company and trading partner companies, and an emission amount calculation unit configured to calculate allocated emission amounts of the trading partner companies allocated to the reporting company using the sales amounts and greenhouse gas emission amounts of the trading partner companies stored in the company database and the transaction amounts acquired by the acquisition unit.

In addition, an information processing method according to another aspect of the present invention includes storing, by a company database, sales amounts and greenhouse gas emission amounts of companies, acquiring, by an acquisition unit, transaction amounts between a reporting company and trading partner companies, and calculating, by an emission amount calculation unit, allocated emission amounts of the trading partner companies allocated to the reporting company using the sales amounts and greenhouse gas emission amounts of the trading partner companies stored in the company database and the transaction amounts acquired by the acquisition unit.

In addition, a program according to still another aspect of the present invention causes an information processing device, which is a computer, to execute storing sales amounts and greenhouse gas emission amounts of companies, acquiring transaction amounts between a reporting company and trading partner companies, and calculating allocated emission amounts of the trading partner companies allocated to the reporting company using the stored sales amounts and greenhouse gas emission amounts of the trading partner companies and the acquired transaction amounts.

### Advantageous Effects of Invention

According to the present invention, the GHG emission amount can be easily calculated.

### BRIEF DESCRIPTION OF DRAWINGS

FIG. 1 A block diagram representing a configuration of an information processing system 1 of an embodiment.

FIG. 2 A diagram representing an example of company information 201 of the embodiment.

FIG. 3 A diagram for describing processing performed by an information processing device 10 of the embodiment.

FIG. 4 A diagram for describing the processing performed by the information processing device 10 of the embodiment.

FIG. 5 A diagram for describing the processing performed by the information processing device 10 of the embodiment.

FIG. 6 A diagram for describing the processing performed by the information processing device 10 of the embodiment.

FIG. 7 A diagram for describing the processing performed by the information processing device 10 of the embodiment.

FIG. 8 A diagram for describing the processing performed by the information processing device 10 of the embodiment.

FIG. 9 A diagram representing an example of an image displayed on a company terminal 30 of the embodiment.

FIG. 10 A sequence diagram representing a flow of processing performed by the information processing system 1 of the embodiment.

FIG. 11 A flowchart representing a flow of processing performed by the information processing device 10 of the embodiment.

FIG. 12 A flowchart representing the flow of the processing performed by the information processing device 10 of the embodiment.

### DESCRIPTION OF EMBODIMENTS

An embodiment of the present invention will be described below with reference to the drawings. In the following description, an example of calculating the emission amount for each category corresponding to Scope 3 defined by a Greenhouse Gas Protocol will be described in the present embodiment. However, the present invention is not limited to this, and the present embodiment can be used to calculate any GHG emission amount defined in various manners.

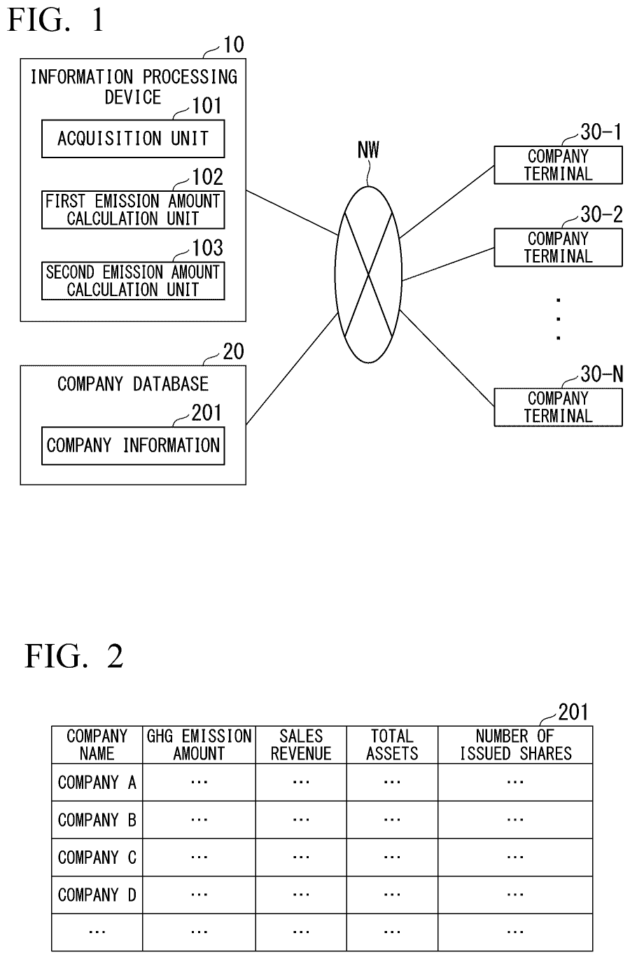

FIG. 1 is a block diagram which shows a configuration of an information processing system 1 of an embodiment. The information processing system 1 includes, for example, an information processing device 10, a company database 20, and a plurality of company terminals 30 (company terminals 30-1, 30-2, . . . , 30-N, where Nis any natural number). Components of the information processing system 1, that is, the information processing device 10, the company database 20, and the plurality of company terminals 30, are connected to each other via a communication network NW in a communicative manner.

The information processing system 1 is a system that provides a service (hereinafter, referred to as a calculation service) that calculates an emission amount corresponding to Scope 3. The calculation service is provided, for example, via dedicated application software (hereinafter, referred to as a calculation application), a web browser, or the like.

The company terminal 30 is a computer managed by a company or the like that uses the calculation service. For example, a server device, a cloud server, a personal computer (PC), a tablet terminal, or the like can be applied as the company terminal 30. For example, a reporting company that reports the emission amount corresponding to Scope 3 in the company is assumed as the company that uses the calculation service. For example, a person in charge or the like uses the company terminal 30 to register for using the calculation service, and the like. This makes it possible that the company terminal 30 uses the calculation service.

The information processing device 10 is a computer managed by a company or the like that provides the calculation service. For example, a server device, a cloud server, a personal computer (PC), or the like can be applied as the information processing device 10. The information processing device 10 calculates the emission amount corresponding to Scope 3 in response to a request from the company terminal 30. A method by which the information processing device 10 calculates the emission amount corresponding to Scope 3 will be described in detail below.

The company database 20 is a database that stores information on companies (company information 201). For example, a server device, a cloud server, a personal computer (PC), or the like can be applied as the company database 20. The company database 20 includes a storage area configured from a storage medium such as an HDD, a flash memory, an electrically erasable programmable read only memory (EEPROM), a random access read/write memory (RAM), or a read only memory (ROM), or a combination of these. The company database 20 stores the company information 201 in this storage area.

In the example of FIG. 1, a case in which the information processing device 10 and the company database 20 are separate devices has been exemplified, but the present invention is not limited thereto. The company information 201 may be stored inside the information processing device 10. In this case, the company database 20 can be omitted.

FIG. 2 is a diagram which shows an example of the company information 201 of an embodiment. The company information 201 includes, as the information on a company, information corresponding to items such as a GHG emission amount in the company, sales revenue, total assets, and the number of issued shares.

The GHG emission amount is an emission amount of GHG emitted by a company. An emission amount of carbon dioxide (CO2) emitted by a company may also be used as the GHG emission amount. The GHG emission amount can be acquired, for example, from a carbon disclosure project (CDP) database, sustainability reports disclosed by each company, and information such as the GHG emission amount calculated by the company itself under an SHK system (a greenhouse gas emission amount calculation, reporting, and publication system).

The sales revenue, total assets, and number of issued shares are sales revenue, total assets, and the number of issued shares of a company. The sales revenue, total assets, and number of issued shares can be acquired, for example, from information such as company information published on a homepage or the like by a company, securities reports, financial statements, and financial announcements published in an official gazette.

The company database 20 also stores an emission basic unit for each category of Scope 3. The emission basic unit can be collected, for example, from an emission basic unit database created as an emission factor in the SHK system.

The company database 20 is used by, for example, periodically or irregularly referring to information published on the Internet, for example, a CDP database or the like, and updating information such as the GHG emission amount stored as the company information 201.

The method by which the information processing device 10 calculates the emission amount corresponding to Scope 3 will be described in detail below.

As shown in FIG. 1, the information processing device 10 includes, for example, an acquisition unit 101, a first emission amount calculation unit 102, and a second emission amount calculation unit 103. Functional units of the information processing device 10, that is, the acquisition unit 101, the first emission amount calculation unit 102, and the second emission amount calculation unit 103, are realized by causing a central processing unit (CPU) provided as hardware by the information processing device 10 to execute a program.

The acquisition unit 101 acquires data necessary for calculating the emission amount corresponding to Scope 3. Here, the data necessary for calculating the emission amount corresponding to Scope 3 is, for example, information indicating a transaction amount between a reporting company and a trading partner company. The data necessary for calculating the emission amount corresponding to Scope 3 may include information indicating the number of shares of the trading partner company held by the reporting company.

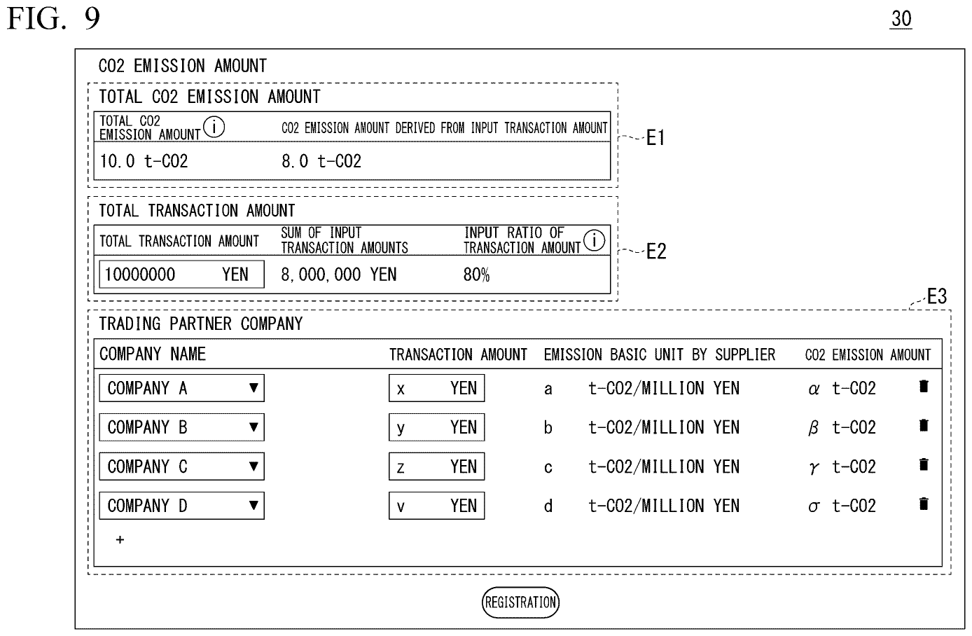

For example, when a calculation application is started by a person in charge or the like of the reporting company operating the company terminal 30, or when a uniform resource locator (URL) for using the calculation service is accessed via a Web browser or the like, the information processing device 10 notifies the company terminal 30 of an input screen (refer to FIG. 9) for calculating the emission amount corresponding to Scope 3. As a result, an input screen as shown in FIG. 9 is displayed on the company terminal 30. The person in charge or the like of the reporting company inputs data such as the transaction amount for each trading partner company at the reporting company according to content displayed on the input screen, and performs registration work by performing an operation of pressing a registration button or other operations. As a result, the company terminal 30 notifies the information processing device 10 of data such as the transaction amount for each trading partner company at the reporting company, which is data necessary for calculating the emission amount corresponding to Scope 3. The acquisition unit 101 acquires the data notified to the information processing device 10 from the company terminal 30 in this manner.

The first emission amount calculation unit 102 calculates an allocated emission amount for each trading partner company using the company information 201 stored in the company database 20 and the data acquired by the acquisition unit 101. The allocated emission amount here is an emission amount allocated to the reporting company out of the GHG emission amount emitted by the trading partner company.

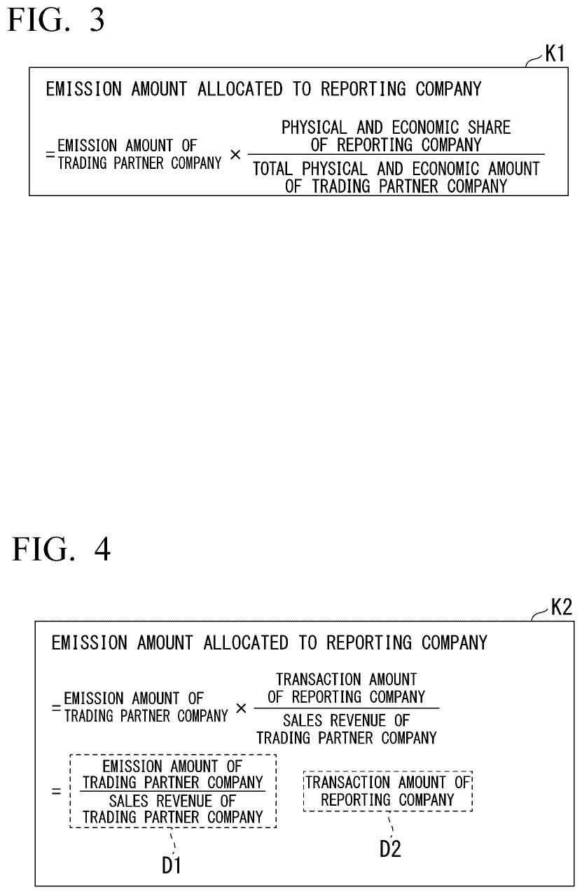

Here, a method by which the first emission amount calculation unit 102 calculates the allocated emission amount will be described in detail using FIGS. 3 to 5. FIGS. 3 to 5 are diagrams for describing processing performed by the information processing device 10 of the embodiment.

FIG. 3 shows a calculation formula K1 of the allocated emission amount described in guidelines, and the like. As shown in the calculation formula K1, an emission amount allocated to the reporting company (allocated emission amount) is one obtained by multiplying “emission amounts of the trading partner companies” by a first ratio. Here, the first ratio is a “physical and economic share of the reporting company” with respect to a “total physical and economic amount of the trading partner companies.”

As shown in FIG. 3, the calculation formula K1 for the allocated emission amount described in the guidelines, and the like, is highly abstract, and knowledge has been required as to how to determine physical amounts corresponding to, for example, the “total physical and economic amount of the trading partner companies” and the “physical and economic share of the reporting company.” In addition, the calculation formula K1 is defined on a premise that the calculation will be performed using data held by the trading partner companies. For this reason, as a specific calculation method, a method has been adopted in which the trading partner companies perform calculation using the calculation formula K1 and the allocated emission amount is calculated by acquiring a result of the calculation (allocated emission amount) from the trading partner companies. Therefore, the reporting company had to make an inquiry about the allocated emission amount to the trading partner companies, which has required a lot of effort and time.

To address this issue, the information processing system 1 of the embodiment uses information such as sales revenue published by the trading partner company, making it possible to calculate the allocated emission amount using only data held by the reporting company. Specifically, the first emission amount calculation unit 102 calculates the allocated emission amount using a calculation formula K2, which is a modified version of the calculation formula K1, the company information 201, and the “transaction amount of the reporting company,” which is data held by the reporting company.

FIG. 4 shows the calculation formula K2 for calculating the allocated emission amount in the embodiment. As shown in the calculation formula K2, the allocated emission amount is calculated by multiplying the “emission amount of the trading partner company” by a second ratio. The second ratio here is the “transaction amount of the reporting company” with respect to “sales revenue of the trading partner company.”

By further modifying the calculation formula K2, the allocated emission amount can be obtained by multiplying the “transaction amount of the reporting company” (a sign D2) by a third ratio. The third ratio is the “emission amount of the trading partner company” with respect to the “sales revenue of the trading partner company” (a sign D1). Here, the third ratio indicated by the sign D1 can be extracted based on the information stored in the company information 201. Moreover, the “transaction amount of the reporting company” indicated by the sign D2 is data held by the reporting company, and can be identified by, for example, extracting purchasing data showing transactions with trading partner companies from purchasing data of the reporting company.

In this manner, in the information processing system 1 of the present embodiment, the allocated emission amount can be calculated using only information such as sales revenue published by the trading partner companies and data held by the reporting company, based on the calculation formula K1 described in the guidelines, and the like. Furthermore, the information such as sales revenue published by the trading partner companies is stored in the company database 20.

Then, the first emission amount calculation unit 102 refers to the company database 20 on the basis of the “sales revenue of the trading partner company” notified by the company terminal 30, and acquires the “emission amount of the trading partner company” and “sales revenue of the trading partner company” for that trading partner company. The first emission amount calculation unit 102 calculates the allocated emission amount using the “sales revenue of the trading partner company” notified by the company terminal 30, and the “emission amount of the trading partner company” and the “sales revenue of the trading partner company” acquired from the company database 20. The allocated emission amount calculated in this manner is notified to the company terminal 30.

As a result, the reporting company can calculate the allocated emission amount of the reporting company in the trading partner company simply by notifying the calculation service of the transaction amount with the trading partner company in the reporting company at any timing when the reporting company intends to calculate the allocated emission amount. Therefore, there is no need to consider how to determine a physical amount corresponding to the “total physical and economic amount of the trading partner company” and the “physical and economic share of the reporting company” or to make an inquiry to the trading partner company. For this reason, it possible to easily calculate the allocated emission amount without spending a lot of time and effort.

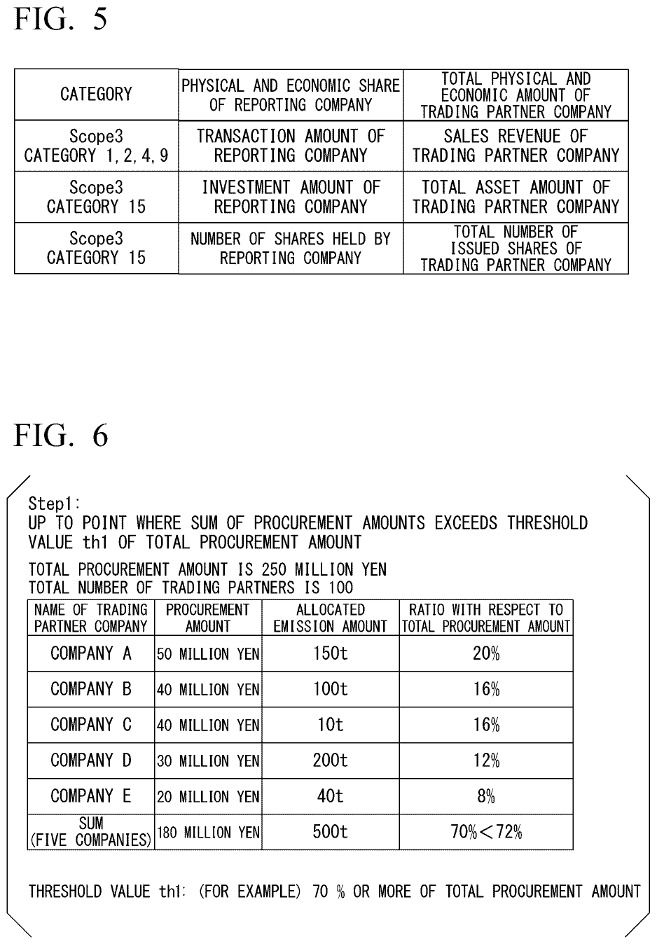

FIG. 5 shows how the calculation formula K1 is interpreted for each category of Scope 3. As shown in FIG. 5, the calculation formula K1 may be modified appropriately for each category.

As shown in FIG. 5, for example, when the allocated emission amounts for category 1, category 2, category 4, and category 9 of Scope 3 are calculated, for example, the “physical and economic share of the reporting company” in the calculation formula K1 is set to the “transaction amount of the reporting company.” In addition, the “total physical and economic amount of the trading partner companies” in the calculation formula K1 is set to the “sales revenue of the trading partner companies.” In this manner, the allocated emission amount can be calculated using the calculation formula K2 described above.

As shown in FIG. 5, for example, when the allocated emission amount for category 15 of Scope 3 is calculated on a monetary basis, for example, the “physical and economic share of the reporting company” in the calculation formula K1 is set to an “investment amount of the reporting company.” The “investment amount of the reporting company” here is an amount invested by the reporting company in the trading partner companies. The “investment amount of the reporting company” is data held by the reporting company, and can be identified by, for example, extracting it from investment data of the reporting company. In addition, the “total physical and economic amount of the trading partner companies” in the calculation formula K1 is set to a “total asset amount of the trading partner companies.” The “total asset amount of the trading partner companies” can be extracted from the company database 20. For example, the first emission amount calculation unit 102 can calculate the allocated emission amount for category 15 of Scope 3 on a monetary basis using Formula (1).

$$Allocated emission amount = Emission amount of trading partner company / Total asset amount of \\ trading partner company \times Investment amount of reporting company \qquad ( 1 )$$

Alternatively, as shown in FIG. 5, when the allocated emission amount for category 15 of Scope 3 is calculated on a stock basis, for example, the “physical and economic share of the reporting company” in the calculation formula K1 is set to the “number of shares held by the reporting company.” The “number of shares held by the reporting company” here is the number of shares of the trading partner company held by the reporting company. The “number of shares held by the reporting company” is data held by the reporting company, and can be identified from, for example, data for shares held by the reporting company. In addition, the “total physical and economic amount of the trading partner company” in the calculation formula K1 is set to the “total number of issued shares of the trading partner company.” The “total number of issued shares of the trading partner company” can be extracted from the company database 20. For example, the first emission amount calculation unit 102 can use Formula (2) to calculate the allocated emission amount for category 15 of Scope 3 on a stock basis.

$$Allocated emission amount = emission amount of trading partner company / total \\ number of shares issued by trading partner company \times the number of shares held by the reporting company \qquad ( 2 )$$

Returning to FIG. 1, the second emission amount calculation unit 103 calculates the total emission amount. The total emission amount is a total amount of the allocated emission amounts of all trading partner companies in the reporting company.

It is common that there are many companies that perform transactions with one company. For this reason, it is not realistic to calculate the allocated emission amounts for all trading partner companies, and there has been a difficulty for a reporting company to calculate the total emission amount.

To address this issue, the information processing system 1 of the embodiment is made to perform a “prolongation calculation” that can calculate a reasonable total emission amount using a sum of the allocated emission amounts calculated for major trading partner companies, without calculating the allocated emission amounts for all trading partner companies.

Here, a method by which the second emission amount calculation unit 103 calculates the total emission amount using the “prolongation calculation” will be described in detail with reference to FIGS. 6 to 8. FIGS. 6 to 8 are diagrams for describing processing performed by the information processing device 10 of the embodiment.

FIG. 6 shows an example as Step 1, in which the allocated emission amounts are calculated up to a point where a sum of procurement amounts exceeds a threshold value th1 of the total procurement amount. A procurement amount here is a transaction amount with the trading partner company. The total procurement amount is a sum of transaction amounts of all trading partner companies. The threshold value th1 may be set arbitrarily, but is set to, for example, 70% or more of the total procurement amount.

As shown in the example of FIG. 6, the total procurement amount of the reporting company is 250 million yen, and the total number of trading partner companies is 100. In this case, the second emission amount calculation unit 103 calculates the threshold value th1 on the basis of the total procurement amount. For example, the second emission amount calculation unit 103 sets the threshold value th1 to 175 million yen, which is 70% of the total procurement amount of 250 million yen. The second emission amount calculation unit 103 acquires, for example, the procurement amounts from trading partner companies in descending order of the procurement amount, and acquires the procurement amounts of the trading partner companies until the sum of the acquired procurement amounts exceeds the threshold value th1. In the example of FIG. 6, the sum of procurement amounts of five trading partner companies from Company A to Company E, is 180 million yen, which exceeds the threshold value th1 of 175 million yen.

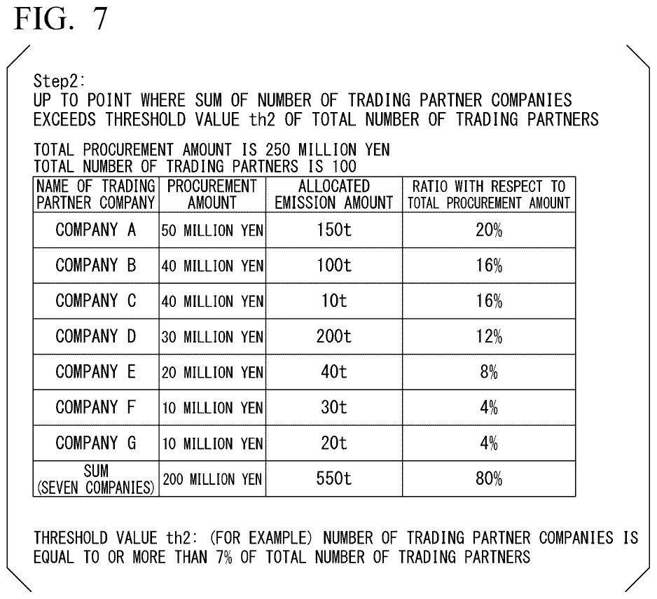

FIG. 7 shows an example as Step 2, in which the allocated emission amounts are calculated up to a point where a sum of the number of trading partner companies exceeds a threshold value th2 of the total number of trading partners. The threshold value th2 may be set arbitrarily, but is set to, for example, 7% or more of the total number of trading partners.

As shown in the examples of FIG. 6 and FIG. 7, it is assumed that the total procurement amount of the reporting companies is 250 million yen, and the total number of trading partner companies is 100. In this case, the second emission amount calculation unit 103 calculates the threshold value th2 on the basis of the total number of trading partners. For example, the second emission amount calculation unit 103 sets the threshold value th2 to seven companies, which is 7% of the total number of trading partners, 100. The second emission amount calculation unit 103 acquires the procurement amounts from trading partner companies, for example, in descending order of the procurement amount, and acquires the procurement amounts of the trading partner companies until a sum of the number of trading partner companies whose procurement amounts have been acquired exceeds the threshold value th2. In the example shown in FIGS. 6 and 7, the procurement amounts of seven trading partner companies, from Company A to Company G, are acquired.

Here, the second emission amount calculation unit 103 calculates variables for performing the “prolongation calculation.” The variables for performing the “prolongation calculation” are a “prolongation ratio” and an “emission amount before prolongation.” Here, the “prolongation ratio” is a ratio of the sum of procurement amounts acquired in Step 1 and Step 2 to the total procurement amount. In the example shown in FIGS. 6 and 7, the “prolongation ratio” is 80%. The “emission amount before prolongation” is a sum of the allocated emission amounts calculated on the basis of the procurement amounts of trading partner companies obtained in Step 1 and Step 2. In the example shown in FIGS. 6 and 7, the “emission amount before prolongation” is 550 [t].

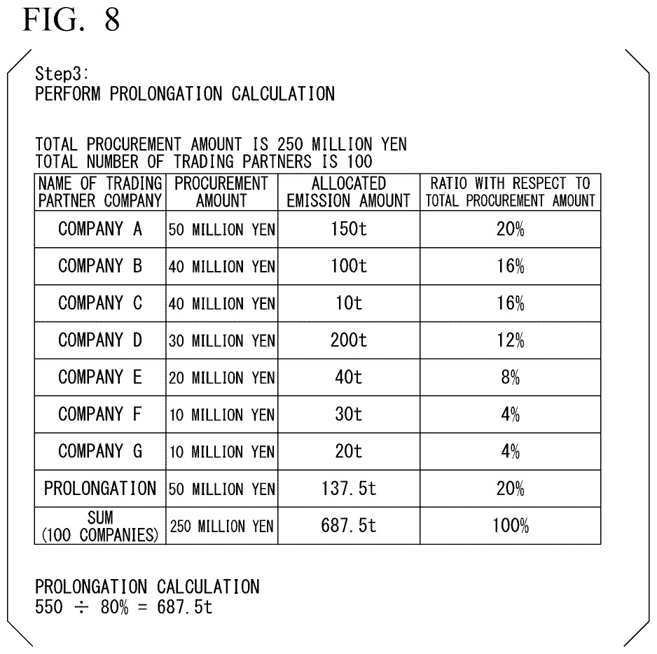

FIG. 8 shows an example as Step 3 in which the total emission amount is calculated using the “prolongation calculation”. The second emission amount calculation unit 103 calculates the total emission amount using the “prolongation calculation” by dividing the “emission amount before prolongation” by the “prolongation ratio.” In the example shown in FIG. 8, the total emission amount using the “prolongation calculation” is calculated as 687.5 [t] by dividing the “emission amount before prolongation” of 550 [t] by the “prolongation ratio” of 80 [%].

FIG. 9 is a diagram which shows an example of an image displayed on the company terminal 30 of the embodiment. For example, when a person in charge or the like of the reporting company operates the company terminal 30 to start up a calculation application, or to access a URL for using the calculation service via a web browser or the like, an input screen such as that shown in FIG. 9 is displayed on the company terminal 30.

As shown in FIG. 9, the input screen displays, for example, an area E1 titled “Total CO2 emission amount,” an area E2 titled “Total transaction amount,” an area E3 titled “Trading partner company,” and an operation button marked “Registration.” The total transaction amount in the area E2, company names and transaction amounts in the area E3, and the like are input, and the operation button marked “Register” is pressed by an operation of a person in charge or the like of the reporting company, data such as the total transaction amount, company names, and transaction amounts are notified to the information processing device 10.

The “total CO2 emission amount” calculated by the information processing device 10 is displayed in the area E1. The “total CO2 emission amount” here is the total emission amount for the reporting company that meets a Scope 3 standard defined by an Effective Gas Protocol. The second emission amount calculation unit 103 calculates the total emission amount using “prolongation calculation” using the company names and a sum of transaction amounts input in the area E3, and the total amount of the allocated emission amounts calculated by the first emission amount calculation unit 102, and the calculated total emission amount is displayed in the area E1.

In the area E2, the total transaction amount for the reporting company is input by a person in charge or the like of the reporting company. The total transaction amount here is a total of transaction amounts with each of all trading partner companies with which the reporting company has performed transactions.

In the area E3, the company name and transaction amount for each trading partner company are input by a person in charge or the like of the reporting company. The area E3 also displays the allocated emission amount for each trading partner company calculated by the first emission amount calculation unit 102 (in FIG. 9, it is written as “CO2 emission amount”). The first emission amount calculation unit 102 calculates the allocated emission amounts by referring to the company database 20 on the basis of the company names and transaction amounts input in the area E3, and the calculated allocated emission amounts are displayed in area E3.

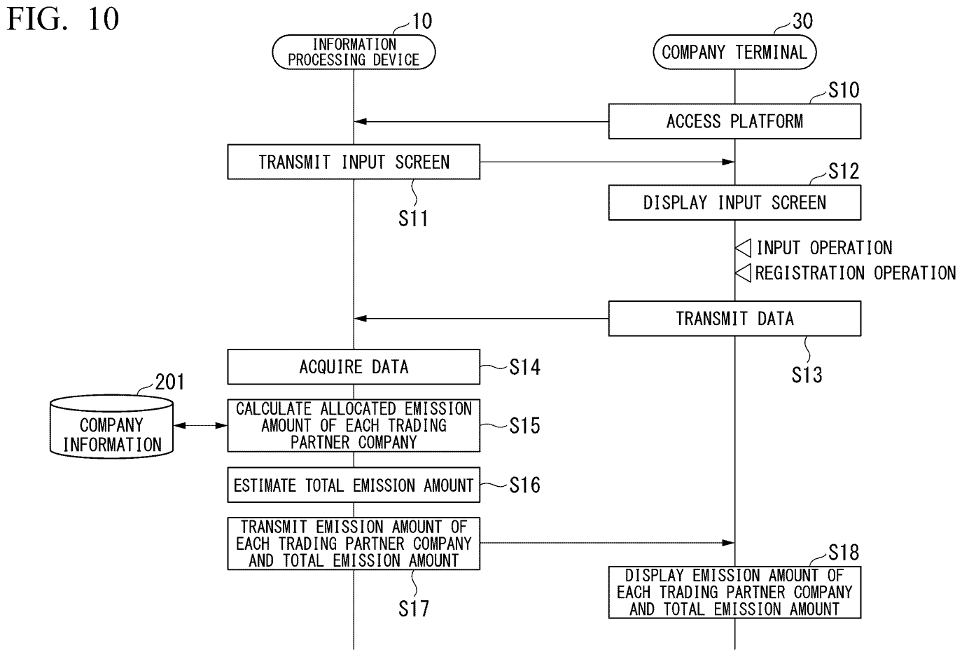

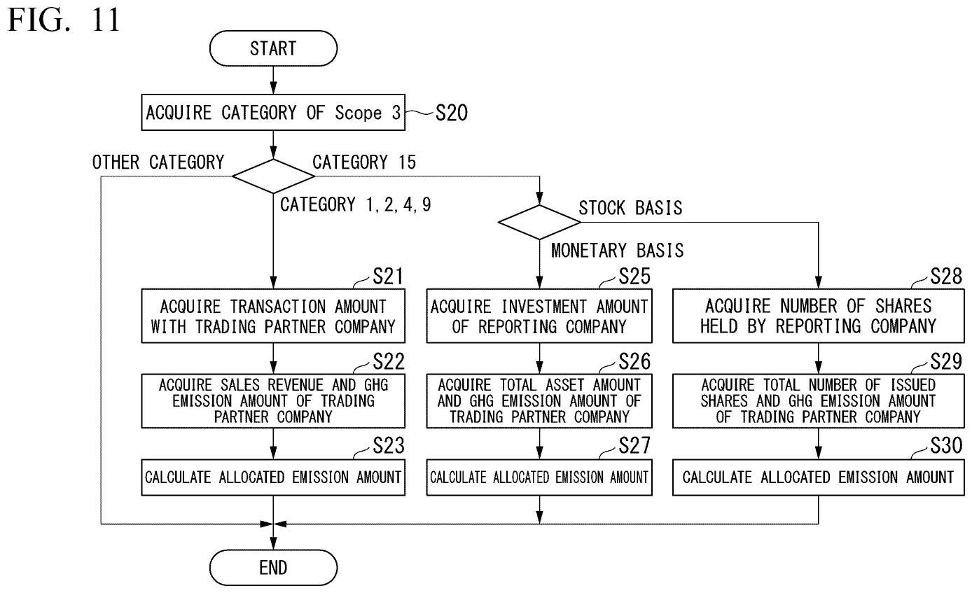

FIG. 10 is a sequence diagram which shows a flow of processing performed by the information processing system 1 of the embodiment. As shown in FIG. 10, first, the company database 20 accesses a platform for calculating the emission amount, such as a calculation application (step S10). Next, the information processing device 10 receives access from the company terminal 30 and notifies the company terminal 30 of information on the input screen as shown in FIG. 9 (step S11). As a result, the company terminal 30 displays the input screen (step S12). The company terminal 30 transmits the data by performing, by a person in charge or the like of the reporting company, an input operation of inputting data, a registration operation of pressing an operation button marked “Register,” and the like (step S13). The data here is data necessary for calculating the allocated emission amount and the total emission amount, and is, for example, information indicating the transaction amounts between the reporting company and the trading partner company, or information indicating the number of shares of the trading partner company held by the reporting company.

The information processing device 10 acquires the data notified from the company terminal 30 (step S14). The information processing device 10 refers to the company database 20 on the basis of the acquired data, and calculates the allocated emission amount for each trading partner company (step S15). The information processing device 10 also calculates the total emission amount by performing a “prolongation calculation” (step S16). The information processing device 10 transmits the allocated emission amount for each trading partner company and the total emission amount to the company terminal 30 (step S17). The company terminal 30 displays the allocated emission amount for each trading partner company and the total emission amount notified by the information processing device 10 (step S18).

FIG. 11 is a flowchart which shows a flow of processing performed by the information processing device 10 of the embodiment. FIG. 11 shows a flow of processing for calculating the allocated emission amount. First, the information processing device 10 acquires a category of Scope 3 (step S20). The category of Scope 3 is specified by, for example, the reporting company. In this case, an input screen as shown in FIG. 9 is provided with an input field for inputting a category. Alternatively, the category may be identified according to a company name, an industry, and the like of the trading partner company input by the reporting company according to the input screen as shown in FIG. 9. In this case, the information processing device 10 stores table information in which the category of Scope 3 corresponds to the company name, industry, and the like of the trading partner company in advance, and acquires the category of Scope 3 by referring to the table information according to the company name, industry, and the like of the trading partner company input by the reporting company.

The information processing device 10 then calculates the allocated emission amount according to the category.

When the category of Scope 3 is any of category 1, category 2, category 4, and category 9, the information processing device 10 acquires a transaction amount with the trading partner company by acquiring data input according to the input screen as shown in FIG. 9 (step S21). Next, the information processing device 10 refers to the company database 20 on the basis of the company name or the like of the trading partner company input according to the input screen as shown in FIG. 9, and acquires sales revenue and a GHG emission amount of the trading partner company (step S22). The information processing device 10 then calculates the allocated emission amount using the transaction amount with the trading partner company acquired in step S21 and the sales revenue and GHG emission amount of the trading partner company acquired in step S22 (step S23).

When the category of Scope 3 is category 15, the information processing device 10 determines whether to calculate the allocated emission amount on a monetary basis or a stock basis. For example, the information processing device 10 determines whether to calculate the allocated emission amount on a monetary basis or a stock basis using a method specified by the reporting company.

When the allocated emission amount is calculated on a monetary basis, the information processing device 10 acquires an investment amount of the trading partner company in the reporting company by acquiring the data input according to the input screen as shown in FIG. 9 (step S25). Next, the information processing device 10 refers to the company database 20 on the basis of the company name or the like of the trading partner company input according to the input screen as shown in FIG. 9, and acquires a total asset amount and a GHG emission amount of the trading partner company (step S26). The information processing device 10 then calculates the allocated emission amount using the investment amount of the trading partner company in the reporting company acquired in step S25, and the total asset amount and GHG emission amount of the trading partner company acquired in step S26 (step S27).

When the allocated emission amount is calculated on a stock basis, the information processing device 10 acquires the number of shares of the trading partner company held by the reporting company by acquiring the data input according to the input screen as shown in FIG. 9 (step S28). Next, the information processing device 10 refers to the company database 20 on the basis of the company name or the like of the trading partner company input according to the input screen as shown in FIG. 9, and acquires the total number of issued shares and GHG emission amount of the trading partner company (step S29). Then, the information processing device 10 calculates the allocated emission amount using the number of shares of the trading partner company held by the reporting company, acquired in step S28, and the total number of issued shares and GHG emission amount of the trading partner company, acquired in step S29 (step S30).

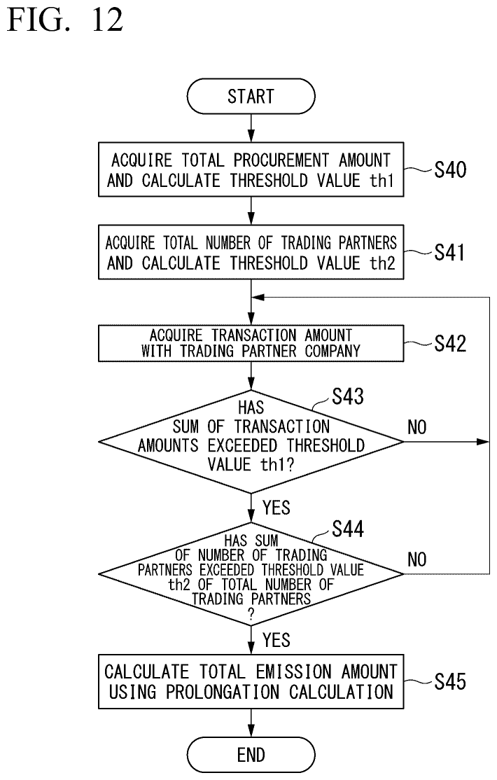

FIG. 12 is a flowchart which shows the flow of the processing performed by the information processing device 10 of the embodiment. FIG. 12 shows a flow of processing for calculating the total emission amount. First, the information processing device 10 acquires the total procurement amount and calculates the threshold value th1 on the basis of the acquired total procurement amount (step S40). In addition, the information processing device 10 acquires the total number of trading partners and calculates the threshold value th2 on the basis of the acquired total number of trading partners (step S41). The information processing device 10 acquires the total procurement amount and the total number of trading partners by acquiring the data input according to the input screen as shown in FIG. 9.

The information processing device 10 acquires transaction amounts with the trading partner companies by the same processing as in step S21 (step S42). The information processing device 10 determines whether a sum of the transaction amounts acquired in step S42 has exceeded the threshold value th1 (step S43), and when the threshold value th1 has not been exceeded, returns to step S42 to acquire a transaction amount with another trading partner company different from the trading partner companies whose transaction amounts have been acquired up to the previous time. When the sum of the transaction amounts acquired in step S42 has exceeded the threshold value th1, the information processing device 10 determines whether a sum of the number of trading partner companies whose transaction amounts have been acquired in step S42 has exceeded the threshold value th2 (step S44). When the threshold value th2 has not been exceeded, the information processing device 10 returns to step S42 to acquire a transaction amount with another trading partner company different from the trading partner companies whose transaction amounts have been acquired up to the previous time. When the threshold value th2 has been exceeded, the information processing device 10 calculates the total emission amount using the prolongation calculation (step S45).

Note that in the flowchart of FIG. 12, an example has been described in which it is determined whether both the threshold values th1 and th2 have been exceeded. However, the present invention is not limited to this. For example, the information processing device 10 may determine only whether the threshold value th1 has been exceeded, and when the threshold value th1 has been exceeded, calculate the total emission amount using the prolongation calculation on the basis of the sum of the transaction amounts already acquired and the sum of the number of trading partner companies whose transaction amounts have been acquired.

Alternatively, the information processing device 10 may determine only whether the threshold value th2 has been exceeded, and when the threshold value th2 has been exceeded, calculate the total emission amount using the prolongation calculation on the basis of the sum of the transaction amounts already acquired and the sum of the number of trading partner companies whose transaction amounts have been acquired.

Moreover, the information processing device 10 may calculate the total emission amount without performing the prolongation calculation. In this case, the information processing device 10 acquires the transaction amounts with all trading partner companies of the reporting company, and calculates the allocated emission amounts corresponding to the acquired transaction amounts. The information processing device 10 sets the sum of the calculated allocated emission amounts as the total emission amount not based on the prolongation calculation. In cases such as when a company does not have a large number of trading partner companies, it is possible to calculate the total emission amount with a realistic processing load even without performing the prolongation calculation.

As described above, the information processing system 1 of the embodiment includes the company database 20, the acquisition unit 101, and the first emission amount calculation unit 102. The first emission amount calculation unit 102 is an example of the “emission amount calculation unit.” The company database 20 stores the company information 201. The company information 201 includes information indicating the sales amounts and greenhouse gas emission amount of the companies. The acquisition unit 101 acquires the transaction amounts between the reporting company and the trading partner companies. The first emission amount calculation unit 102 calculates the allocated emission amounts. The allocated emission amounts are the emission amounts of the trading partner companies allocated to the reporting company. The first emission amount calculation unit 102 calculates the allocated emission amounts using the sales amounts and greenhouse gas emission amounts of the trading partner companies stored in the company database 20, and the transaction amounts acquired by the acquisition unit 101.

As a result, the information processing system 1 of the embodiment can calculate the allocated emission amounts using the information indicating the sales amounts and greenhouse gas emission amounts of the companies, which is information stored in the company database 20, and the transaction amounts with the trading partner companies, which are data held by the reporting company. Therefore, it becomes possible to easily calculate the allocated emission amounts without spending a lot of time and effort.

Moreover, in the information processing system 1 of the embodiment, there are a plurality of categories corresponding to content of transactions between the reporting company and the trading partner company. For example, there are 15 categories of Scope 3 defined by the Greenhouse Gas Protocol. The first emission amount calculation unit 102 calculates a divided value obtained by dividing the “emission amount (greenhouse gas emission amount) of the trading partner company” by the “sales revenue (sales amount) of the trading partner company” for at least one category out of the plurality of categories. The first emission amount calculation unit 102 calculates a multiplied value, as the allocated emission amount, obtained by multiplying the divided value by the “transaction amount.” For example, the first emission amount calculation unit 102 calculates a divided value obtained by dividing the “emission amount (greenhouse gas emission amount) of the trading partner company” by the “sales revenue (sales amount) of the trading partner company,” and sets the calculated value as the allocated emission amount corresponding to at least one of categories 1, 2, 4, and 9 of a Scope 3 standard defined by the Greenhouse Gas Protocol. In this manner, the information processing system 1 of the embodiment can easily calculate the allocated emission amount corresponding to at least one category.

Furthermore, in the information processing system 1 of the embodiment, the first emission amount calculation unit 102 calculates a divided value obtained by dividing the “emission amount (greenhouse gas emission amount) of the trading partner company” by the “total asset amount of the trading partner company” in at least one category out of the plurality of categories. The first emission amount calculation unit 102 calculates a multiplied value, as the allocated emission amount, obtained by multiplying the divided value by the “investment amount of the reporting company (in the trading partner company).” For example, the first emission amount calculation unit 102 calculates a divided value obtained by dividing the “emission amount (greenhouse gas emission amount) of the trading partner company” by the “total asset amount of the trading partner company,” and sets the calculated value as the allocated emission amount corresponding to category 15 of the Scope 3 standard defined by the Greenhouse Gas Protocol. As a result, in the information processing system 1 of the embodiment, the allocated emission amount corresponding to at least one category can be easily calculated on a monetary basis.

Furthermore, in the information processing system 1 of the embodiment, the first emission amount calculation unit 102 calculates a divided value obtained by dividing the “emission amount (greenhouse gas emission amount) of the trading partner company” by the “total number of shares of the trading partner company” in at least one category among the plurality of categories. The first emission amount calculation unit 102 calculates a multiplied value obtained by multiplying the divided value by the “number of shares of the trading partner company held by the reporting company” as the allocated emission amount. For example, the first emission amount calculation unit 102 calculates a multiplied value obtained by multiplying the divided value, obtained by dividing the “emission amount (greenhouse gas emission amount) of the trading partner company” by the “total number of issued shares of the trading partner company,” by the “number of shares of the trading partner company held by the reporting company,” and sets the calculated value as the allocated emission amount corresponding to category 15 of the Scope 3 standards defined by the Greenhouse Gas Protocol. In this manner, the information processing system 1 of the embodiment can easily calculate the allocated emission amount corresponding to at least one category on a stock basis.

Furthermore, in the information processing system 1 of the embodiment, the acquisition unit 101 acquires the transaction amount with each trading partner company so that the sum of the transaction amounts exceeds the threshold value th1 (a first threshold value) for the total procurement amount of the reporting company. The second emission amount calculation unit 103 estimates the total amount of the allocated emission amounts of all trading partner companies in the reporting company on the basis of the allocated emission amounts of the trading partner companies whose transaction amounts have been acquired, for example, using the prolongation calculation. The second emission amount calculation unit 103 sets the estimated total amount as the total emission amount. The second emission amount calculation unit 103 is an example of an “emission amount calculation unit.” As a result, in the information processing system 1 of the embodiment, it is possible to estimate the allocated emission amounts for all trading partner companies using transaction amounts that account for a certain ratio without using the transaction amounts with all trading partner companies, making it possible to easily calculate the total emission amount with a high likelihood.

In addition, in the information processing system 1 of the embodiment, the acquisition unit 101 acquires the transaction amount of each trading partner company so that the total number of trading partner companies whose transaction amounts have been acquired exceeds the threshold value th2 (a second threshold value) for the total number of trading partner companies in the reporting company. The second emission amount calculation unit 103 estimates the total amount of the allocated emission amounts of all trading partner companies in the reporting company on the basis of the allocated emission amounts of the trading partner companies whose transaction amounts have been acquired, for example, using the prolongation calculation. The second emission amount calculation unit 103 sets the estimated total amount as the total emission amount. As a result, in the information processing system 1 of the embodiment, it is possible to estimate the allocated emission amount for all trading partner companies using the transaction amounts of a certain number of trading partner companies without using the transaction amounts with all trading partner companies, making it possible to easily calculate the total emission amount with a high likelihood.

Furthermore, in the information processing system 1 of the embodiment, the acquisition unit 101 acquires the transaction amount of each trading partner company so that the sum of the transaction amounts exceeds the threshold value th1 (a first threshold value) for the total procurement amount of the reporting company, and the total number of trading partner companies whose transaction amounts have been acquired exceeds the threshold value th2 (a second threshold value) for the total number of trading partner companies at the reporting company. The second emission amount calculation unit 103 estimates the total allocated emission amount of all trading partner companies at the reporting company on the basis of the allocated emission amount of trading partner companies whose transaction amounts have been acquired using, for example, the prolongation calculation. The second emission amount calculation unit 103 sets the estimated total amount as the total emission amount. As a result, in the information processing system 1 of the embodiment, it is possible to estimate the allocated emission amounts for all trading partner companies using transaction amounts that account for a certain ratio and the number of trading partner companies without using the transaction amounts with all trading partner companies, making it possible to easily calculate the total emission amount with a high likelihood.

All or part of functions of the information processing system 1 and the information processing device 10 in the embodiment described above may be realized by a computer. In that case, the functions may be realized by recording a program for realizing the functions on a computer-readable recording medium, and causing a computer system to read and execute the program recorded on the recording medium. Note that the term “computer system” here includes an OS and hardware such as peripheral devices. In addition, the term “computer-readable recording medium” refers to portable media such as flexible disks, optical magnetic disks, ROMs, and CD-ROMs, and storage devices such as hard disks and the like embedded into the computer system. Furthermore, the term “computer-readable recording medium” may include a recording medium that dynamically stores a program for a short period of time, such as a communication line when transmitting a program via a network such as the Internet or a communication line such as a telephone line, or a recording medium that stores a program for a certain period of time, such as a volatile memory inside the computer system that serves as a server or client in such a case. The program may be a program for realizing part of the functions described above, may be a program that can realize the functions described above in combination with a program already recorded in the computer system, or may be a program that is realized using a programmable logic device such as a field programmable gate array (FPGA).

The above describes the embodiment of the present invention in detail with reference to the drawings, but a specific configuration is not limited to the present embodiment, and designs and the like within a range not departing from a gist of the present invention are also included.

### REFERENCE SIGNS LIST

1 Information processing system
10 Information processing device
101 Acquisition unit
102 First emission amount calculation unit (emission amount calculation unit)
103 Second emission amount calculation unit (emission amount calculation unit)
20 Company database
201 Company information
30 Company terminal

1. An information processing system comprising:
a company database configured to store sales amounts and greenhouse gas emission amounts of companies;
an acquisition unit configured to acquire transaction amounts between a reporting company and trading partner companies; and
an emission amount calculation unit configured to calculate allocated emission amounts of the trading partner companies allocated to the reporting company using the sales amounts and greenhouse gas emission amounts of the trading partner companies stored in the company database and the transaction amounts acquired by the acquisition unit.

2. The information processing system according to claim 1,
wherein the acquisition unit acquires the transaction amount of each of the trading partner companies so that a sum of the transaction amounts exceeds a first threshold value for a total procurement amount in the reporting company, and
the emission amount calculation unit estimates a total amount of the allocated emission amounts of all trading partner companies in the reporting company on the basis of the allocated emission amounts of each of the trading partner companies whose transaction amounts are acquired, and sets the estimated total amount as a total emission amount of the reporting company.

3. The information processing system according to claim 1,
wherein the acquisition unit acquires the transaction amount of each of the trading partner companies so that the total number of the trading partner companies whose transaction amounts are acquired exceeds a second threshold value for the number of all trading partner companies in the reporting company, and
the emission amount calculation unit estimates a total amount of the allocated emission amounts of each of all trading partner companies in the reporting company on the basis of the allocated emission amounts of each of the trading partner companies whose transaction amounts are acquired, and sets the estimated total amount as a total emission amount of the reporting company.

4. The information processing system according to claim 1,
wherein the acquisition unit acquires the transaction amounts of each of the trading partner companies so that a sum of the transaction amounts exceeds a first threshold value for a total procurement amount in the reporting company, and the total number of the trading partner companies whose transaction amounts are acquired exceeds a second threshold value for the number of all trading partner companies in the reporting company, and
the emission amount calculation unit estimates a total amount of the allocated emission amounts of each of all trading partner companies in the reporting company on the basis of the allocated emission amounts of each of the trading partner companies whose transaction amounts are acquired, and sets the estimated total amount as a total emission amount of the reporting company.

5. The information processing system according to claim 1,
wherein there are a plurality of categories corresponding to content of transactions between the reporting company and the trading partner companies, and
the emission amount calculation unit calculates, for at least one of the plurality of categories, a multiplied value, as the allocated emission amount, obtained by multiplying the transaction amount by a divided value obtained by dividing a greenhouse gas emission amount of the trading partner company by the sales amounts of the trading partner company.

6. An information processing method performed by a computer, comprising:
storing, by a company database, sales amounts and greenhouse gas emission amounts of companies;
acquiring, by an acquisition unit, transaction amounts between a reporting company and trading partner companies; and
calculating, by an emission amount calculation unit, allocated emission amounts of the trading partner companies allocated to the reporting company using the sales amounts and greenhouse gas emission amounts of the trading partner companies stored in the company database and the transaction amounts acquired by the acquisition unit.

7. A program causing an information processing device, which is a computer, to execute:
storing sales amounts and greenhouse gas emission amounts of companies; acquiring transaction amounts between a reporting company and trading partner companies; and
calculating allocated emission amounts of the trading partner companies allocated to the reporting company using the stored sales amounts and greenhouse gas emission amounts of the trading partner companies and the acquired transaction amounts.
